(19) United States
(12) Patent Application Publication
(10) Pub. No.: US 2009/0216630 A1
(43) Pub. Date: Aug. 27, 2009

(54) CONTENT MONETIZATION SYSTEM WITH VARIABLE AD INSERTION

(75) Inventor: JEFFREY D. CARNAHAN, New York, NY (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/035,874

(22) Filed: Feb. 22, 2008

(51) Int. Cl. G06Q 30/00; G06F 17/00

(52) U.S. Cl. 705/14; 726/1

(57) ABSTRACT

A user's experience with content on a device can be impacted based on the disposition of the content and the type of device. The user can experience a wealth of advertisements when consuming content that has no license. Likewise, the user can experience little or no advertisements when consuming content that has a license. The amount of advertisements are determined by a set of monetization rules as well as by the amount of authorization remaining in the license. Further, the user's ability to control the device when rendering the content is determined by the monetization rules which are influenced by the licensing status of the content.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Users playing content on a device can receive incentives to perform specific actions by varying the quantity and selection of advertising that they receive, or varying the content options that users may have. The incentives also benefit content providers by providing revenues.

A standard “one size fits all” approach for ad insertion into content is not the most consumer-friendly method to regulate all commercial content. Reducing the number of ads incorporated into commercial content can serve as an incentive for users to perform desirable actions. These actions might include purchasing a product, enrolling into a subscription service, sharing content with others, or performing another action that benefits the content producer.

Dynamically varying how a user may consume content can provide an incentive to perform desirable actions. These actions might include restricting playback controls such as rewind, fast-forward, or skip. These actions might also include limiting how much content can be consumed such as how many times the content can be viewed or how much of the content can be viewed before additional funding or licensing is required from the user.

### SUMMARY

The present invention is defined by the claims below. Embodiments of the present invention solve at least the above problems by providing a medium, system, and apparatus for regulating advertisement delivered with content and controlling a use of the content.

A user's experience with content delivered to a device can vary depending on the licensing status of the content. For content with no license, a complement of advertisements can play with the content or a default set of rules can be applied by a monetization engine. In addition, the user can have limited or no control of the device or content while the advertisement or content plays. For content with a license, little or no advertisement can play with the content or another set of rules can be applied by the monetization engine. In addition, the user can have full control of the device or content. The number of advertisements and range of control can vary depending on the licensing status of the content as well as the amount of times the content has been played. All aspects of the number of advertisements, verification of licensing status, the loading of advertisements and content on the device can be governed by rules operated by a monetization service.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a block diagram of an exemplary monetization system implemented when practicing an embodiment of the present invention;

FIG. 2 is a block diagram of an exemplary watermarking system implemented when practicing an embodiment of the present invention;

FIG. 3 is a block diagram of an exemplary device implemented when practicing an embodiment of the present invention;

FIG. 4 is a block diagram of an exemplary operating environment implemented when practicing an embodiment of the present invention;

FIG. 5 is a flowchart of an exemplary process for regulating advertisement in a device when practicing an embodiment of the present invention;

FIG. 6 is a flowchart of an exemplary process for controlling content when practicing an embodiment of the present invention;

FIG. 7 is a flowchart of an exemplary process for operating a monetization engine when practicing an embodiment of the present invention; and

FIG. 8 is a flowchart of another exemplary process for operating a monetization engine when practicing an embodiment of the present invention.

### DETAILED DESCRIPTION

Embodiments of the present invention provide a medium, system, and apparatus for regulating advertisement delivered with content and controlling a use of the content.

Many different arrangements of the various components depicted, as well as components not shown, are possible without departing from the spirit and scope of the present invention. Embodiments of the present invention will be described with the intent to be illustrative rather than restrictive. Alternative embodiments will become apparent to those skilled in the art. A skilled artisan may develop alternative means of implementing improvements without departing from the scope of the present invention.

### Acronyms and Shorthand Notations

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention. The following is a list of these acronyms:

| | |
|---|---|
| CD | Compact Disc |
| CD-ROM | Compact Disc-Read-Only Memory |
| DRM | |
| DVD | Digital Versatile Discs |
| EEPROM | Electrically Erasable Programmable Read-only |
| | Memory |
| MP3 | MPEG-1 Audio Layer 3 |
| PC | Personal Computer |
| PDA | Personal Digital Assistant |
| RAM | Random Access Memory |
| ROM | Read-Only Memory |

Further, various technical terms are used throughout this description. A definition of such terms can be found in Newton's Telecom Dictionary by H. Newton, 23^{rd} Edition (2007). These definitions are intended to provide a clearer understanding of the ideas disclosed herein but are not intended to limit the scope of the present invention. The definitions and terms should be interpreted broadly and liberally to the extent allowed the meaning of the words offered in the above-cited reference.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

### Variable Monetization Effort

In a scenario, imagine a person has compiled a digital mix-tape, a musical playlist, and has sent it to a friend. If the friend already has a license to all of the content in the mix, the friend should hear no ads and have full control over the playback. At the other extreme, if the friend does not own any of the content in the mix, the friend may be required to listen to advertisements without rewind or fast-forward controls. If the friend owns some of the content in the mix, the number of ads and playback controls can vary depending on how much is owned by the friend. This scenario represents aspects that are implemented in embodiments of the present invention.

In implementing an embodiment of the present invention, rules governing how content is monetized can be established. The rules are applied to content or stored as default in a device capable of consuming that content. When the content is consumed, the capable device dynamically adds advertising and control options. The device has an ability to report advertising statistics and obtain new advertising media from a central monetization service.

To better understand the present invention, a set of terms are defined and explained below to help the reader.

Monetization rules are a set of expressions that indicate the quantity and/or type of advertising, and/or consumption controls assigned to a specific piece of content or a set of content. Monetization rules may be “ad rules” which influence selection and quantity of advertising. Monetization rules may also be “consumption rules” which influence the behavior of device-specific consumption controls. For example, the following rules may apply to a collection of music: Unlicensed music released in the past three (3) months must be monetized at a rate of $0.25 per minute. Unlicensed music released more than three (3) months ago must be monetized at a rate of $0.30 per minute. Unlicensed music must not be played more than three (3) times. Unlicensed music may not be rewound or fast-forwarded. Unlicensed music may not be shared with users in other countries.

Consumption controls are various ways content can be consumed or not consumed on a capable device. For example, an audio player may provide controls such as skip, rewind, fast-forward, volume, and rating. A web browser may provide controls including navigational, print, bookmark, and rating.

A capable device or device may be any device that contains a monetization engine that determines how the device shall execute or obey rules. The device can directly or indirectly communicate with a monetization service to perform such functions as provide ad statistics or exchange ad media.

A monetization engine is a software component that resides within a capable device. The monetization engine is responsible for executing and applying the monetization rules. It interacts with the device so that the device can modify consumption controls and insert advertising when content is consumed. The monetization engine can obtain advertising media from a source.

A monetization service is a centralized service that sets the monetization rules, collects statistics on consumed content, collects statistics on consumed advertising, identifies available advertising media, and provides advertising media to the device.

Monetization rules are specific to an ecosystem of capable devices. The rules used to govern music monetization on a music player can be different from the rules used to govern text monetization on a portable eBook reader or rules used to govern information within a virtual gaming environment. The available set of rules can be governed by the monetization service and a default set of rules can be defined for each ecosystem of capable devices.

Monetization rules can be categorized into two classes: Ad rules influence which ads are inserted into content or how many ads are inserted into the content. Consumption rules influence how the content may be consumed. A reference to the term monetization rules includes both ad rules and consumption rules.

A content producer that desires to further monetize or control content especially beyond a level defined by the default rules can define additional rules called content-specific rules. This definition can be done through an interface into the monetization service. The rules can be applied to the content manually by the content producer. The rules can also be saved within the monetization service and applied to content served through the service automatically. The monetization service or other interface may enforce the rules such that certain minimum thresholds be met. An exemplary threshold could be that each piece of content collects a certain monetary amount in ad revenue.

If content-specific rules are not constructed in advance, the monetization service can dynamically add a default set of rules to all content served through the monetization service. The monetization service can also set the rules as defaults in the devices.

To apply monetization rules to selected content, the content producer or monetization service can encode content with the rules. DRM or a permanent watermarking technology can be used to associate the rules with the content. Specifically, watermarking can be used to apply content-specific monetization rules. Watermarking does not limit access to the content since it is acceptable to play content that is not watermarked.

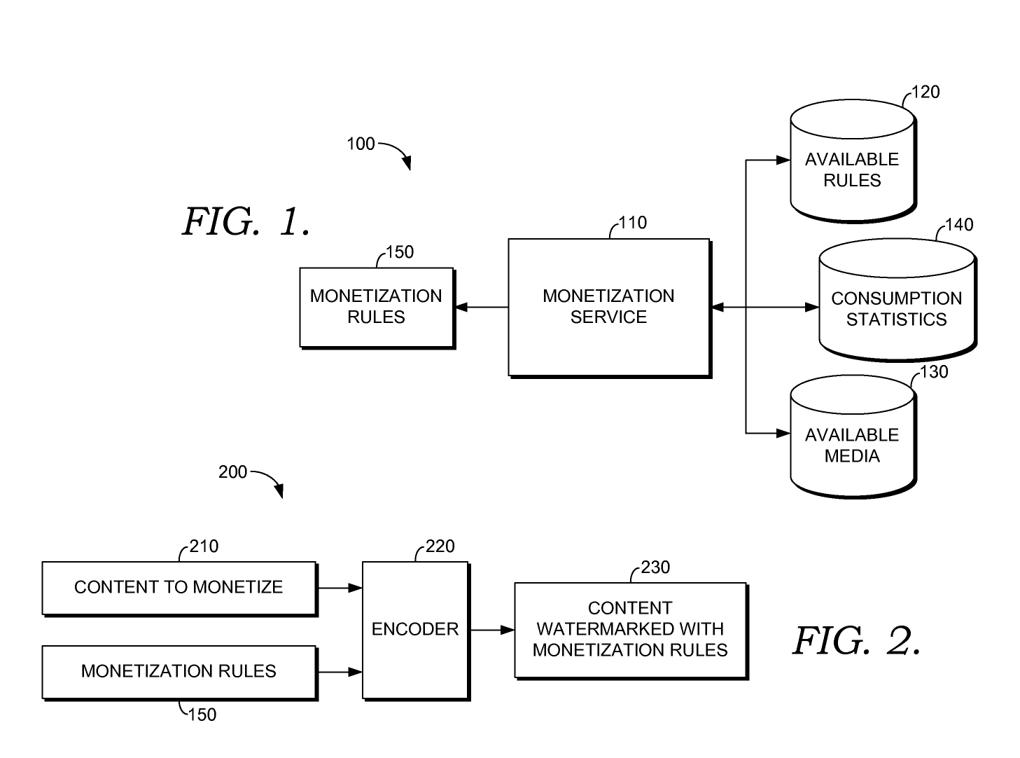

To further understand the terms and the descriptions above, FIG. 1 illustrates a monetization system 100 with a monetization service 110, an available rules 120, advertising media 130, consumption statistics 140, and monetization rules 150. Monetization service 110 obtains rules from available rules 120. Based on knowledge about the content or the device where the content is intended to reside or play, monetization service 110 can create monetization rules 150 to operate on the device. Monetization service 110 can also retrieve ads from advertising media 130 to play with the content delivered to the device. In return, monetization service 110 can retrieve statistical information from the device and deliver it to consumption statistics 140.

Turning now to FIG. 2, a watermarking system 200 is shown with an encoder 220 that receives a content 210 and monetization rules 150. Encoder 220 outputs regulated content 230. Regulated content 230 is watermarked content with monetization rules. Watermarked content can be consumed on a capable device. It is noted that watermarking system 200 can exist in different forms in various embodiments. Watermarking system 200 can exist as part of monetization system 100 described in FIG. 1 or it can exist as a standalone system. It is also noted that the capable device need not require all content be watermarked.

A capable device uses a set of default monetization rules or content-specific monetization rules to determine how content may be consumed. The term consumed is used to denote playing, executing, or operating. As stated above, the monetization engine is used to evaluate the rules and apply consumption restrictions on the content. Or, the monetization engine can insert advertising as dictated by the rules.

The available set of rules for a group of devices relies on the abilities of the monetization engine. For example, if the monetization engine is to add advertising to unlicensed content, the monetization engine has the ability to determine the licensing status for the content. The monetization engine also has the ability to obtain and integrate advertising into the user experience. If the monetization engine is to disallow fast-forwarding, for example, the monetization engine can disable the functionality when necessary.

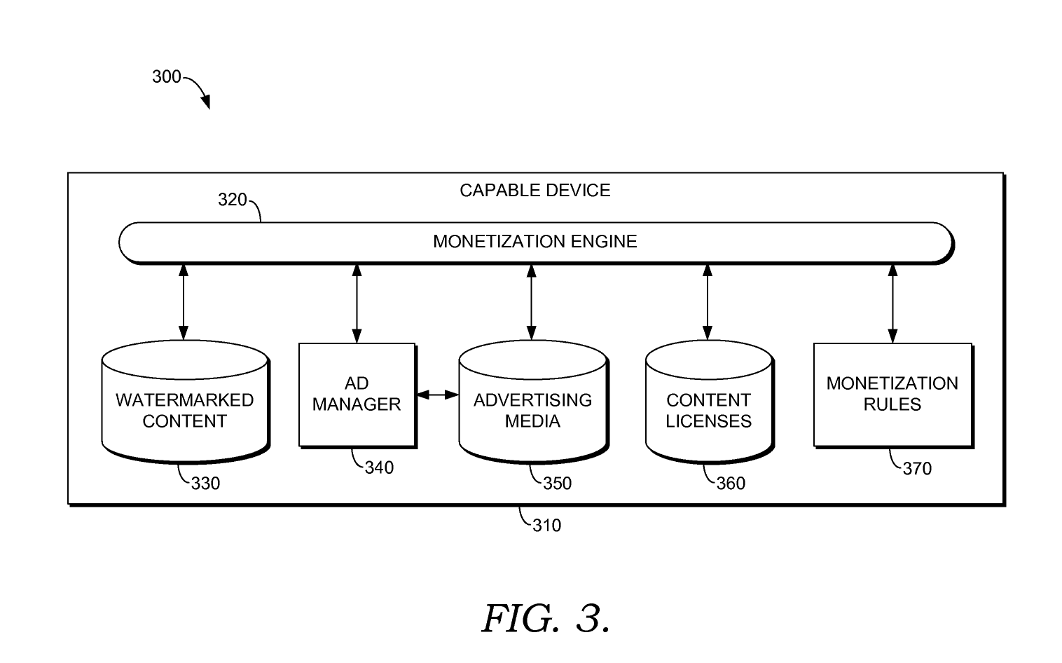

In FIG. 3, an exemplary device 300 is shown with a capable device 310 with monetization engine 320, watermarked content 330, ad manager 340, advertising media 350, content licenses 360, and monetization rules 370.

As shown in FIG. 3, monetization engine 320 coordinates how watermarked and un-watermarked content is consumed on capable device 310. Watermarked content 330 is typically a location to store content that has been watermarked or is about to be watermarked. Monetization engine 320 can retrieve content that has been watermarked from watermarked content 330 when a user desires to consume such content on capable device 310. Although not shown, monetization engine 320 can retrieve un-watermarked content as well. In an alternative embodiment, an implementer can store content regardless of whether it is watermarked or un-watermarked.

Ad manager 340 is connected to monetization engine 320 and advertising media 350. In an implementation of embodiment of the present invention, ad manager 340 monitors the retrieval of ads that are to be integrated with the content. However, in other embodiments, ad manager 340 can perform various functions depending on the implementation of the embodiment such as managing how ads are stored or retrieved, determining how ads are replenished on capable device 310 such as when new ads are stored and when old ads are removed, selecting the appropriate ad when instructed by monetization engine 320, and determining how ads are integrated with the content.

Advertising media 350 is a type of data store that holds the ads that are delivered to capable device 310. As discussed above, typically, ads are stored in advertising media 130 in monetization system 100. At some point, based on the rules, ads in advertising media 130 are delivered to advertising media 350 on capable device 310. The selection of the ads to be stored in advertising media 350 is governed by monetization service 110. The selection of the ads to be consumed on capable device 310 is governed by monetization engine 320 and ad manager 340. If capable device 310 does not have ad manager 340 in the implementation of the embodiment, then the selection is governed by monetization engine 320 alone.

Content licenses 360 are connected to monetization engine 320. As the name implies, content licenses 360 hold licenses. The license can be a digitally signed data file, text file, or other trustworthy piece of data.

Monetization rules 370 hold the rules that govern how content is to be consumed on capable device 310. Depending on the implementation of the embodiment of the present invention, monetization rules 370 can hold default rules, content-specific rules, or both. Typically, the rules in monetization rules 370 are retrieved or received from monetization rules 150 in monetization system 100.

It is noted that capable device 310 illustrated some exemplary components in FIG. 3 for an implementation of an embodiment of the present invention. For example, capable device 310 can manipulate watermarked content in watermarked content 330. Capable device 310 can manipulate licensed content. However, in other embodiments not shown, capable device 310 can manipulate un-watermarked or watermark-free content. Likewise, capable device 310 can manipulate unlicensed content.

Capable devices are able to connect to the monetization service to report monetization statistics and obtain new advertising media. A monetization rule can enforce this activity, for example, by disabling consumption of the content unless new advertising media is acquired or unless statistical information is delivered back to the monetization service. These actions insure that the capable devices periodically connect to the monetization service.

The statistical information can be provided by the component which manages advertising in capable device 310 such as the ad manager. Or, the statistical information can be provided by a separate component in capable device 310 which collects overall consumption statistics. Once the statistical information is delivered to the monetization service, the monetization service uses the statistical information to determine which advertising media should be provided to capable device 310. In the same or a different embodiment, the monetization service can determine the amount of compensation for the content producer for the consumption of his or her content.

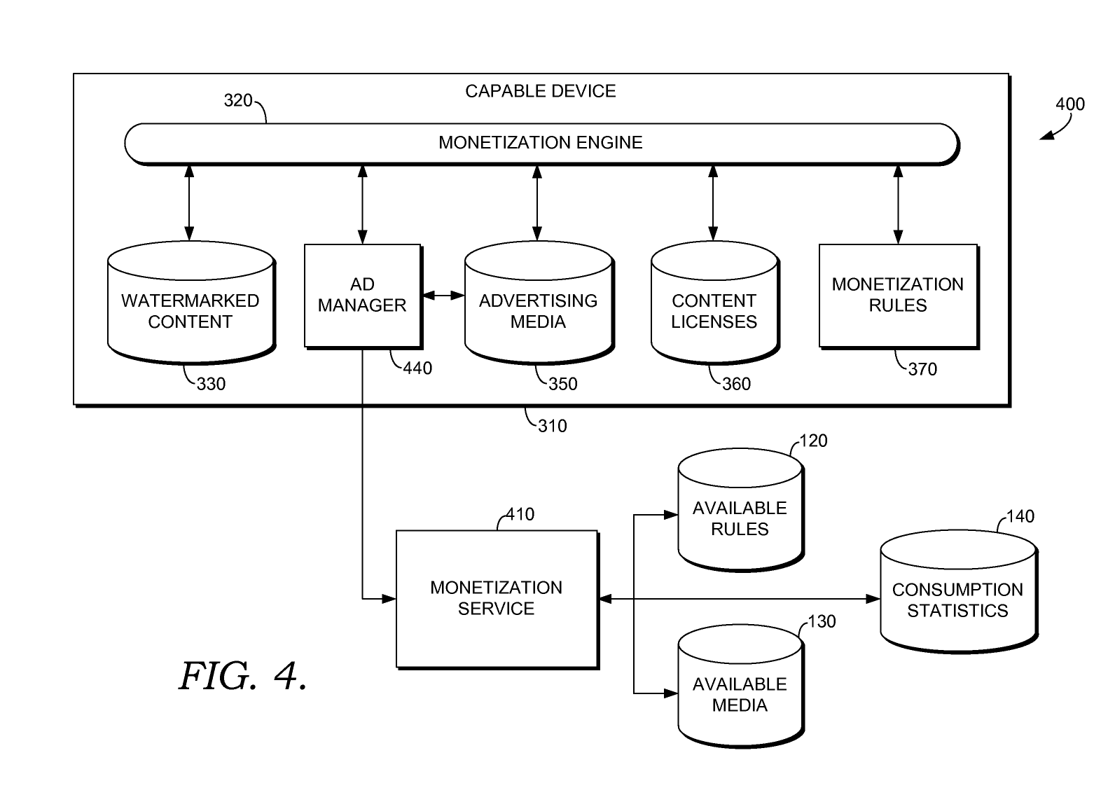

Turning now to FIG. 4, an overall illustration is provided that shows how monetization system 100 is linked to capable device 310 in operating environment 400. Since both monetization system 100 and capable device 310 were described above in FIGS. 1 and 3, their information need not be repeated here. However, ad manager 440 in capable device 310 connects to monetization service 410. The idea here illustrates that capable device 310 obtains new rules to be able to determine how content will be consumed. Likewise, capable device 310 has to report statistical information to monetization service 410 about how ads are consumed. This statistical information is delivered to consumption statistics 140.

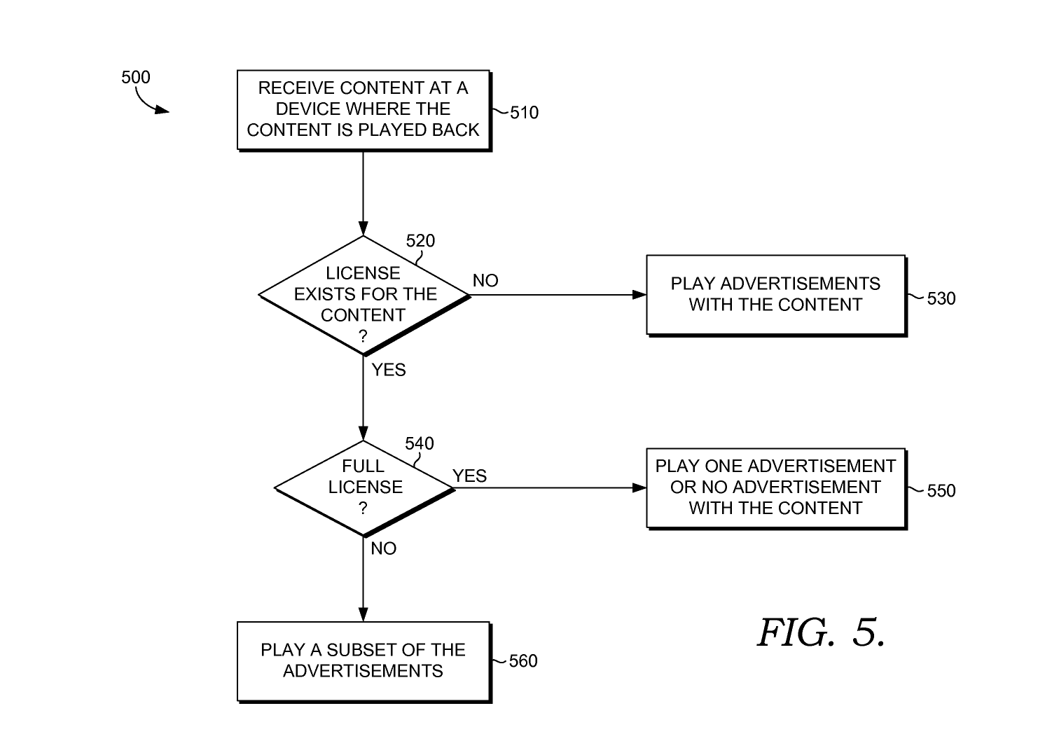

In FIG. 5, a process for regulating advertisement in capable device 310 is shown in a method 500. In a step 510, content is received at capable device 310 where it is to be played. In a step 520, monetization engine 320 determines if a license exists for the content. If no license exists, advertisements are played with the content in a step 530. More specifically, advertisements are encountered by the user when the user plays the content. This could mean that advertisements are played before or after the content is rendered to the user.

If a license exists from the determination in step 520, in a step 540, a determination is made whether the license is a full license or a partial license. A full license provides the user with a full access to the content as determined by a content provider or monetization rules 150 or 370. A partial license provides the user with less than the full access to the content. The issue of what is less than full access is based on an implementation of an embodiment of the present invention. The understanding here is that the partial license results in some type of access to the content which is less than the access given to the user when the content has a full license.

When it is determined that a full license exists, in a step 550, either one advertisement or no advertisement is played with the content. However, when it is determined that a partial license exists, in a step 560, a subset of the advertisements is played with the content. One of ordinary skill in the art can see the correlation between the content, licenses, and advertisements. The more likely a content has a license that tends towards a full license, the less likely advertisements will be rendered with the content when played on capable device 310. In contrast, if the content has no license or a small remaining license authorization, the more likely the user may encounter advertising when the content is played.

The aspects above can be extended further in other embodiments to encompass control of capable device 310. A correlation can be made between the content, licenses, advertisements, and consumption control. In addition to the description above, a content with a full license may result in the user having full access and control over the content in capable device 310. However, the same user may have limited control with a partial license and may have no control over the content when the content has no license. The variation in control of the device and the content is determined by monetization rules 150 and 370.

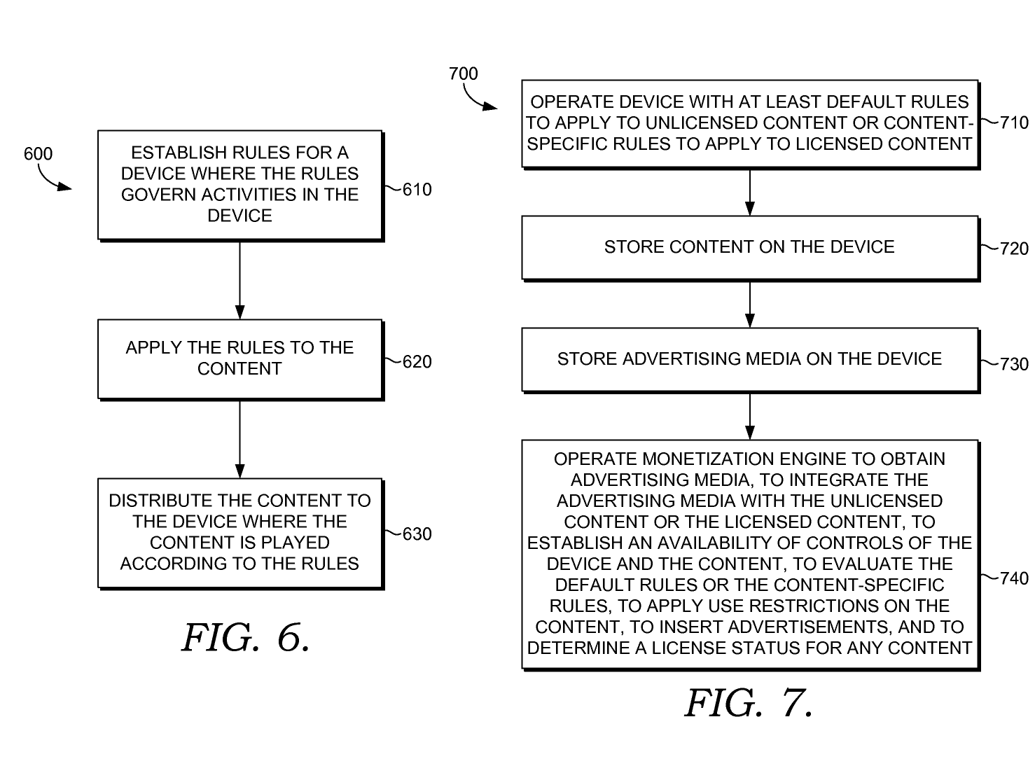

Turning now to FIG. 6, a process for controlling content is shown in a method 600. In a step 610, monetization rules 150 and 370 are established for capable device 310 to govern activities in capable device 310. These rules can specifically target all devices of a particular class, meaning that the rules can vary from one class of devices to another. For example, rules for an eBook player can be different from rules for an MP3 player. Or, the rules can target the content that is received at capable device 310. For example, rules for a video file can be different than rules for an audio file. Further, monetization rules 150 or 370 can be separated into default rules and content-specific rules.

In a step 620, monetization rules 150 or 370 are applied to the content. In the context of monetization rules 150, the rules are applied to the content in monetization system 100 before the content is delivered to capable device 310. In the context of monetization rules 370, the rules are applied to the content in capable device 310. In a step 630, the content is distributed to capable device 310 where the content is played according to the rules. Step 630 is more indicative of when monetization rules 150 are applied to the content in monetization system 100. Subsequent to the action, the content is distributed to capable device 310.

In FIG. 7, a process for operating a monetization engine is shown in a method 700. In a step 710, capable device 310 operates with at least default rules to apply to unlicensed content or content-specific rules to apply to licensed content. In a step 720, the content is stored on capable device 310 at watermarked content 330 or some other location. In a step 730, advertising media is stored on capable device 310. The storing of advertising media is identified by advertising media 350 from FIG. 3.

In a step 740, monetization engine 320 operates to perform a myriad of functions on capable device 310. Monetization engine 320 operates to obtain advertising media, to integrate the advertising media with the unlicensed content or the licensed content, to establish an availability of controls of the device and the content, to evaluate the default rules or the content-specific rules, to apply use restrictions on the content, to insert advertisements during the rendering of the content, and to determine a license status for the content.

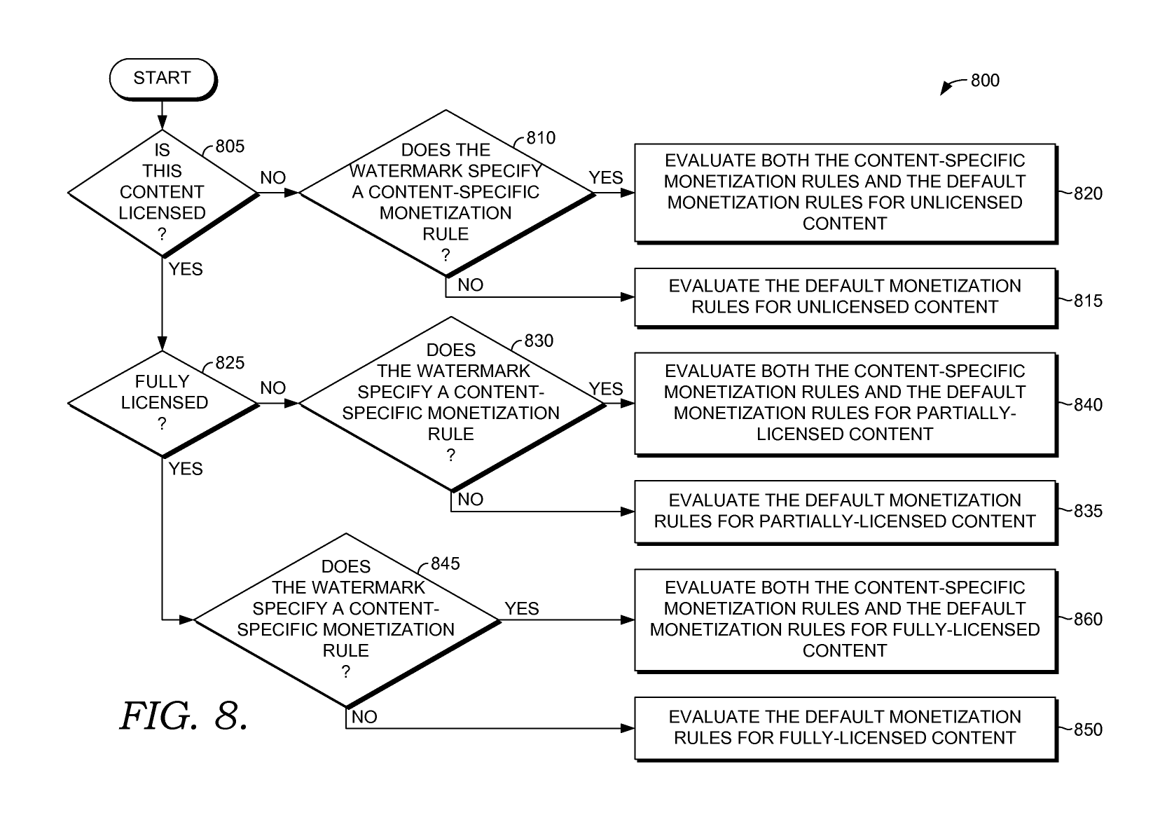

In FIG. 8, another process for operating a monetization engine is shown in a method 800. FIG. 8 is an illustration of an alternative embodiment of the present invention where the existence or inexistence of a license for a content does not influence the type of advertising to be played but does influence the rules that are applied by the monetization engine. For example, a default set of monetization rules may apply when no license exists. A second set of monetization rules may apply when the content is partially licensed. A third set of monetization rules may apply when the content is fully licensed. In addition, these rules may be combined with content-specific monetization rules which are created based on the watermarking technology.

In a step 805, a determination is made whether content is licensed. If the content is not licensed, in a step 810, a determination is made whether a watermark exists and specifies a content-specific monetization rule. If no watermark exists or the watermark does not specify the content-specific monetization rule, default monetization rules are evaluated for the unlicensed content in a step 815. If the watermark specifies the content-specific monetization rule, both default monetization rules and content-specific monetization rules are evaluated for the unlicensed content in a step 820.

Going back to step 805, if the content is licensed, a determination is made whether the content is fully licensed in step 825. If the content is not fully licensed or is partially licensed, in a step 830, a determination is made whether a watermark exists and specifies a content-specific monetization rule. If no watermark exists or the watermark does not specify the content-specific monetization rule, default monetization rules are evaluated for the partially-licensed content in a step 835. If the watermark specifies the content-specific monetization rule, both default monetization rules and content-specific monetization rules are evaluated for the partially-licensed content in a step 840.

Going back to step 825, if the content is fully licensed, in a step 845, a determination is made whether a watermark exists and specifies a content-specific monetization rule. If no watermark exists or the watermark does not specify the content-specific monetization rule, default monetization rules are evaluated for the fully-licensed content in a step 850. If the watermark specifies the content-specific monetization rule, both default monetization rules and content-specific monetization rules are evaluated for the fully-licensed content in a step 860.

A scenario may be described that provides a better understanding to the concepts that have been discussed in this specification. Consider the ZUNE portable player and PC ZUNE application both by Microsoft Corporation of Redmond, Wash. These two capable devices could have a default set of monetization rules defined by the ZUNE service. These rules might require certain advertising be inserted for every three (3) unlicensed tracks played. This arrangement would enable users to create their own custom music playlists. The playlists could be shared with other users. Users who do not own the music would be exposed to significant advertising. Users who own some of the tracks would receive less advertising, and users who own the ZUNE subscription would hear little, if any, advertising. The ZUNE subscription would grant a license to nearly every track in the ZUNE Marketplace.

In another scenario, consider a virtual world similar to SECOND LIFE by Linden Research, Inc. of San Francisco, Calif. Users might construct virtual furniture and define a certain monetization threshold if another user decides to incorporate the furniture into their virtual home. As a home is filled with a large amount of unlicensed furniture, walls of the home could be filled with advertisements. A purchase of the furniture or perhaps an upgrade in the subscription plan could reduce or eliminate the advertising.

In yet a variation to the SECOND LIFE scenario above, a user creates a very comfortable sofa, but defines a single consumption rule that prevents people from sitting on the sofa unless they license the sofa. Other users could put the sofa in their virtual home but would be unable to sit on the sofa until they purchased a license. It is noted in this scenario that no advertising rules are used which is possible with an implementation of an embodiment of the present invention.

The prior discussion is only for illustrative purposes to convey exemplary embodiments. The steps discussed in FIGS. 5-8 may be executed without regards to order. Some steps may be omitted and some steps may be executed at a different time than shown. For example, step 550 may be executed before step 530. Step 730 may be executed before step 720. The point here is to convey that the figures are merely exemplary for the embodiments of the present invention and that other embodiments may be implemented for the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable storage media having computer instructions embodied thereon for performing a method for regulating advertisements delivered with a content, the method comprising:
receiving the content at a device or an application wherein the content is to be played;
determining whether a license exists for the content;
if no license exists, playing a set of advertisements with the content;
if the license exists, determining whether a partial license or a full license exists wherein the full license provides a user with a full access to the content as determined by a content provider and the partial license provides the user with less than the full access;
if the partial license exists, playing a subset of the set of advertisements with the content; and
if the full license exists, playing one advertisement or no advertisements with the content.

2. The media of claim 1, further comprising providing a limited control or no control, of the device or the application, to the user where no license exists and when the set of advertisements are played with the content wherein the limited control allows the user a limited manipulation of the content in the device or the application as determined by the content provider.

3. The media of claim 2, further comprising providing more than the limited control, of the device or the application, to the user where the partial license exists and when the subset of the set of advertisements are played with the content.

4. The media of claim 3, further comprising providing a full control, of the device or the application, to the user where the full license exists and wherein the full control allows the user full manipulation of the content in the device or the application as determined by the content provider.

5. The media of claim 4, wherein the content is selected from a first group including an audio content, a video content, and a document content.

6. The media of claim 5, wherein the device is selected from a second group including a portable player, a PDA, and a mobile device.

7. The media of claim 6, wherein if no license exists, playing the set of advertisements with the content comprises:
applying a first set of rules in the device or the application according to an inexistence of the license;
selecting the set of advertisements to play; and
enabling the limited control or no control of the device or the application.

8. The media of claim 7, wherein if the partial license exists, playing the subset of the set of advertisements with the content comprises:
applying a second set of rules in the device or the application according to an existence of the partial license;
selecting the subset of the set of advertisements to play; and
enabling more than the limited control of the device or the application.

9. The media of claim 8, wherein if the full license exists, playing one advertisement or no advertisements with the content comprises:
applying a third set of rules in the device or the application according to the existence of the full license;
selecting one advertisement or no advertisements to play; and
enabling the full control of the device or the application.

10. A system having at least a computer with a memory for controlling a use of a content, comprising:
establishing rules for a device wherein the rules govern a plurality of activities in the device;
applying the rules to the content; and
distributing the content to the device wherein the content is played according to the rules.

11. The system of claim 10, further comprising:
applying a default set of rules when no license exists;
applying a second set of rules when a partial license exists;
applying a third set of rules when a full license exists; and
if a content-specific set of rules exists, applying the content-specific set of rules to the content with the default set of rules, the second set of rules, or the third set of rules.

12. The system of claim 11, wherein the default set of rules, the second set of rules, or the third set of rules determine if advertisements are played, how many advertisements are played, or which advertisements are played.

13. The system of claim 10, wherein the rules are determined based on at least one of the content and the device.

14. The system of claim 13, wherein the rules determine how many advertisements are played or which advertisements are played.

15. The system of claim 14, wherein the rules determine how the content is used.

16. The system of claim 10, wherein applying the rules to the content comprises at least one of applying the rules to the content in the computer or in the device.

17. The system of claim 10, wherein the rules are applied when the content is played.

18. The system of claim 17, wherein applying the rules to the content comprises encoding the content with the rules.

19. The system of claim 18, wherein encoding the content comprises implementing a DRM technology or a watermarking technology.

20. A device having a processor, a memory, and a monetization engine for operating a content, comprising:
the device operable with at least one of a default set of rules to apply to unlicensed content and content-specific rules to apply to licensed content;
the device operable to store the content;
the device operable to store advertising media; and
the monetization engine operable:
to obtain the advertising media to store on the device;
to integrate the advertising media with the unlicensed content or the licensed content for a user's experience;
to establish an availability of controls of the device and the content;
to evaluate the default set of rules or the content-specific rules;
to apply use restrictions on the content based on the default set of rules or the content-specific rules;
to insert advertisements as governed by the default set of rules or the content-specific rules; and
to determine a license status for any content.

21. The device of claim 20, further comprising the device operable with the default set of rules to apply to licensed content when the content-specific rules are unavailable.

22. The device of claim 20, further comprising the device operable to connect to a service to report statistics on an amount of advertising that occurs on the device and to obtain new advertising media.
